(19) United States
(12) Patent Application Publication
(10) Pub. No.: US 2016/0069541 A1
(43) Pub. Date: Mar. 10, 2016

(54) LAMP

(71) Applicant: HON HAI PRECISION INDUSTRY CO., LTD., New Taipei (TW)

(72) Inventor: CHIH-CHUN HUANG, New Taipei (TW)

(21) Appl. No.: 14/684,005

(22) Filed: Apr. 10, 2015

(30) Foreign Application Priority Data
Sep. 5, 2014 (CN) 201410450720.8

(51) Int. Cl. F21V 17/10; F21V 3/00; F21V 23/00; F21V 15/01

(52) U.S. Cl. CPC F21V 17/10; F21V 15/01; F21V 3/00; F21V 23/002

(57) ABSTRACT

A lamp includes a shell, a lamp head, and an electrical cable. The shell has an outer surface and an inner surface. The inner shell surface defines a recess and two or more locking pieces extending out from the exterior surface. The lamp head has an exterior surface and a locking portion extending out from the exterior portion. The electrical cable has a first end connected to the lamp head and a second end extending into the shell recess. The two or more locking pieces are configured to form one or more locking grooves. The locking portion is releasably receivable into the one or more locking groove locking the lamp head to the shell. The second end of the electrical cable is connectable to a light positioned in the shell recess with the lamp head, electrical cable and light cooperating to form a circuit loop.

### FIELD

The subject matter herein generally relates to a lamp

### BACKGROUND

Lamps are widely applied to a plurality of places for illumination and decoration, such as a commercial place or a residential place. The lamps have a plurality of different forms as achieved desire.

### BRIEF DESCRIPTION OF THE DRAWINGS

Implementations of the present technology will now be described, by way of example only, with reference to the attached figures.

FIG. 1 illustrates an assembled, isometric view of a lamp.

FIG. 2 is an exploded view of the lamp of FIG. 1.

FIG. 3 is similar to FIG. 2, but viewed from another angle.

FIG. 4 is an isometric view of the lamp of FIG. 1, but in a different configuration.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

A lamp can include a shell, a lamp head, and an electrical cable. The shell can have an outer surface and an inner surface. The inner shell surface can define a recess and two or more locking pieces extending out from the exterior surface. The lamp head can have an exterior surface and at least one locking portion extending out from the exterior portion. The electrical cable can have a first end connected to the lamp head and a second end extending into the shell recess. The two or more locking pieces can be configured to form one or more locking grooves. The at least one locking portion can be releasably receivable into the one or more locking groove locking the lamp head to the shell. The second end of the electrical cable can be connectable to a light positioned in the shell recess with the lamp head, electrical cable and light cooperating to form a circuit loop.

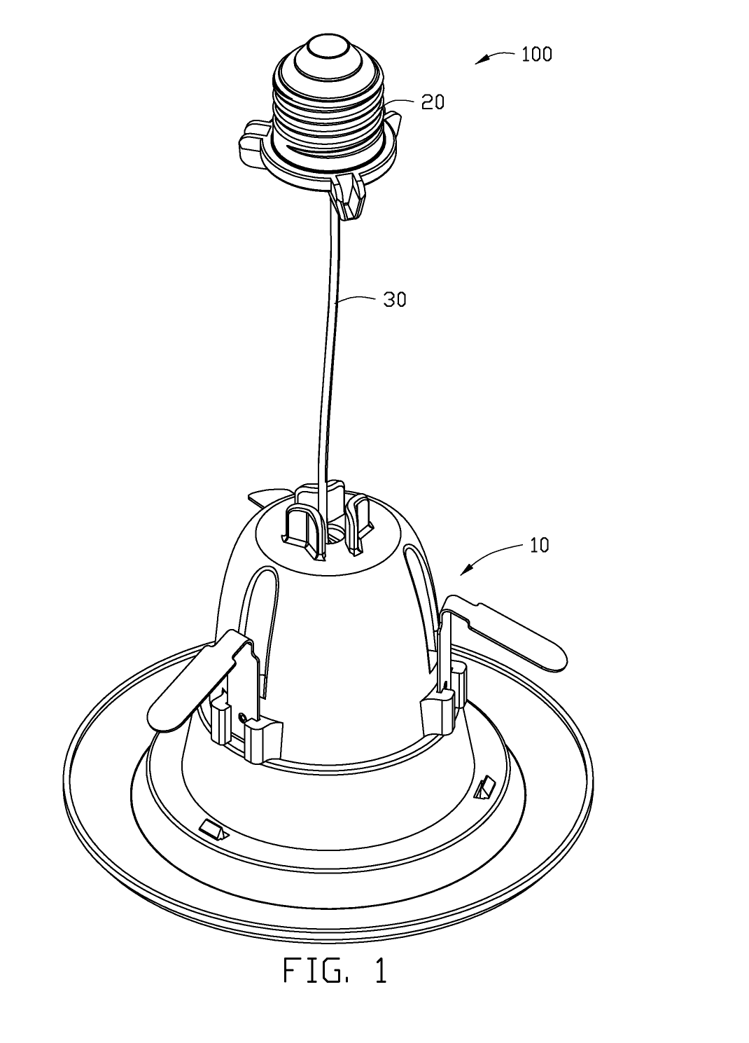

FIG. 1 illustrates a lamp 100 including a shell 10, a lamp head 20 coupled to the shell 10, and an electrical cable 30 coupled to the shell 10 and the shell 10. A distance between the shell 10 and the lamp head 20 can be adjusted in use. A light can be positioned in the shell 10 for illumination. The lamp head 20 can be electrically coupled to an external power source, and can form a circuit loop with a light in the shell 10 via the electrical cable 30.

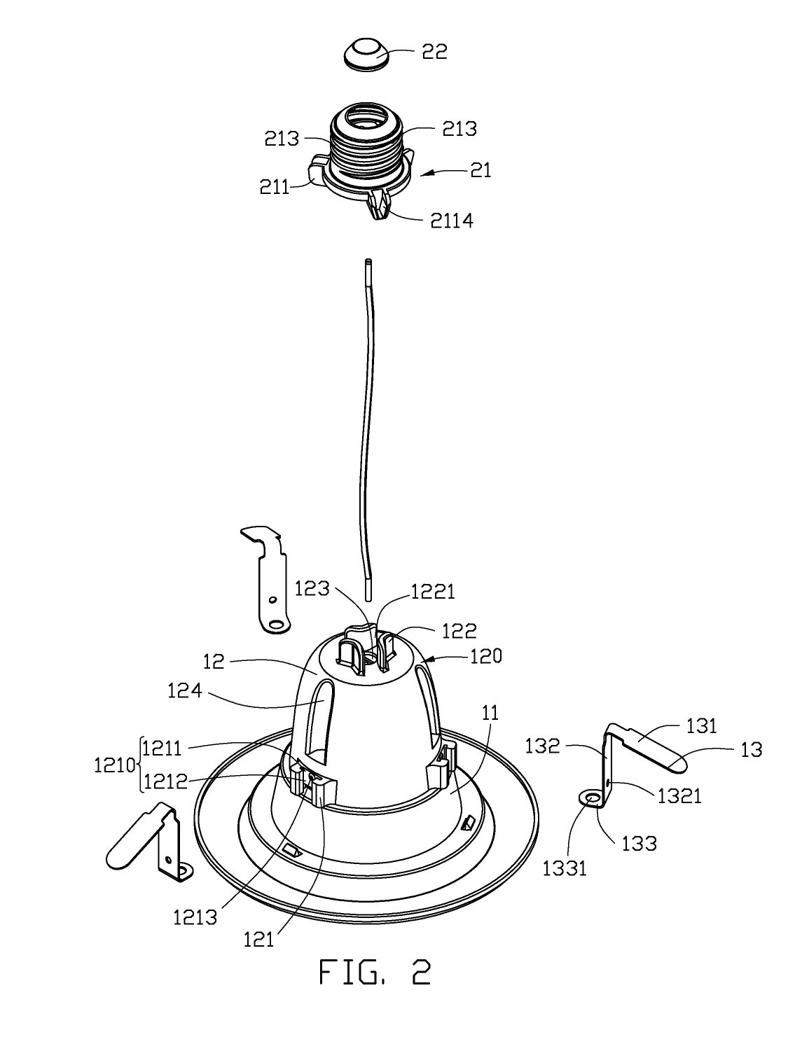

FIG. 2 illustrates the shell 10 can include a first housing 11, a second housing 12 coupled to the first housing 11 at one end, and a plurality of clamp pieces 13 interconnecting between the first housing 11 and the second housing 12. A light, a circuit board and other functional electrical elements can be positioned in the first housing 11, but it is not described here for simplicity.

The second housing 12 can include a base body 120 and a plurality of protrusions 121, and a plurality of locking pieces 122. The plurality of protrusions 121 can separately protrude from an outer wall of the base body 120 adjacent to the first housing 11. In the illustrated embodiment, a number of the protrusions 121 is three. A receiving groove 1210 can be defined in each protrusion 121. The receiving groove 1210 can include a first receiving portion 1211 and a second receiving portion 1212 coupled to the first receiving portion 1211. The first receiving portion 1211 can be positioned adjacent to the base body 120. A width of the first receiving portion 1211 can be greater than a width of the second receiving portion 1212. A fastening hole 1213 can be defined in a bottom wall of the receiving groove 1210. The locking pieces 122 can protrude from an end of the second housing 12 away from the first housing 11 and can be spaced from each other. Each locking piece 122 can be a bent slice. Each two adjacent locking pieces 122 of the plurality of locking pieces 122 can cooperatively form a locking groove 1221. A first through hole 123 defined in the end of the second housing 12 adjacent to the first housing 11. The plurality of locking pieces 122 can positioned around the first through hole 123.

Each clamp piece 13 can be fixed in a respective one receiving groove 1210. Each clamp piece 13 can include a main body 131, a first fixing portion 132, and a second fixing portion 133. The first fixing portion 132 coupled to an end of the main body 131. The second fixing portion 133 can extend from an end of the first fixing portion 132 away from the main body 131. A fastening hole 1331 can be defined in the first fixing portion 132. A fastening hole 1331 can be defined in the second fixing portion 133. An end of the first fixing portion 132 adjacent to the second fixing portion 133 can be received in the first receiving portion 1211 and fastened with the base body 120 by a fastener (not shown). The second fixing portion 133 can be fixed on a surface of the first housing 11 adjacent to the second housing 12 via a fastener (not shown) passing the fastening hole 1331.

In other embodiments, the second housing 12 can be fastened with the first fixing portion 132 and the first housing 11 can be fastened with the second fixing portion 133 with other methods. For example, the second housing 12, the first fixing portion 132, and the first housing 11 can be integrally formed.

In other embodiments, the second fixing portion 133 can be omitted, and the clamp piece 13 can be fastened with the second housing 12 by the first fixing portion 132 and the first housing 11 and the second housing 12 can be directly coupled together.

In other embodiments, the second receiving portion 1212 can be omitted.

In other embodiments, the number of locking pieces 122 is at least two, and the number of the locking portion 211 is at least two.

Three retaining grooves 124 can be further separately defined in the base body 120 corresponding to the three clamp pieces 13, and then it is more convenient for a respective one clamp piece 13 coupling with outer structure.

The lamp head 20 can include a main body 21 and a conductive portion 22 coupled to an end of the main body 21 away from the second housing 12. A plurality of locking portions 211 can be formed on an end of the main body 21 adjacent to the second housing 12 corresponding to the plurality of the locking grooves 1221. Each locking portion 211 can be received in a respective one locking groove 1221, and clamped by respective two locking pieces 122. Each locking portion 211 can include a first resisting board 2111, a second resisting board 2112, and a bottom board 2113. The first resisting board 2111 and the second resisting board 2112 can oppositely protrude from a surface of the lamp head 20 adjacent to the second housing 12. The bottom board 2113 can be coupled between the first resisting board 2111 and the second resisting board 2112. The bottom board 2113 can be positioned adjacent to the shell 10. The first resisting board 2111 and the second resisting board 2112 can resist against a respective one locking piece 122 when the locking portion 211 is received in the locking groove 1221, respectively.

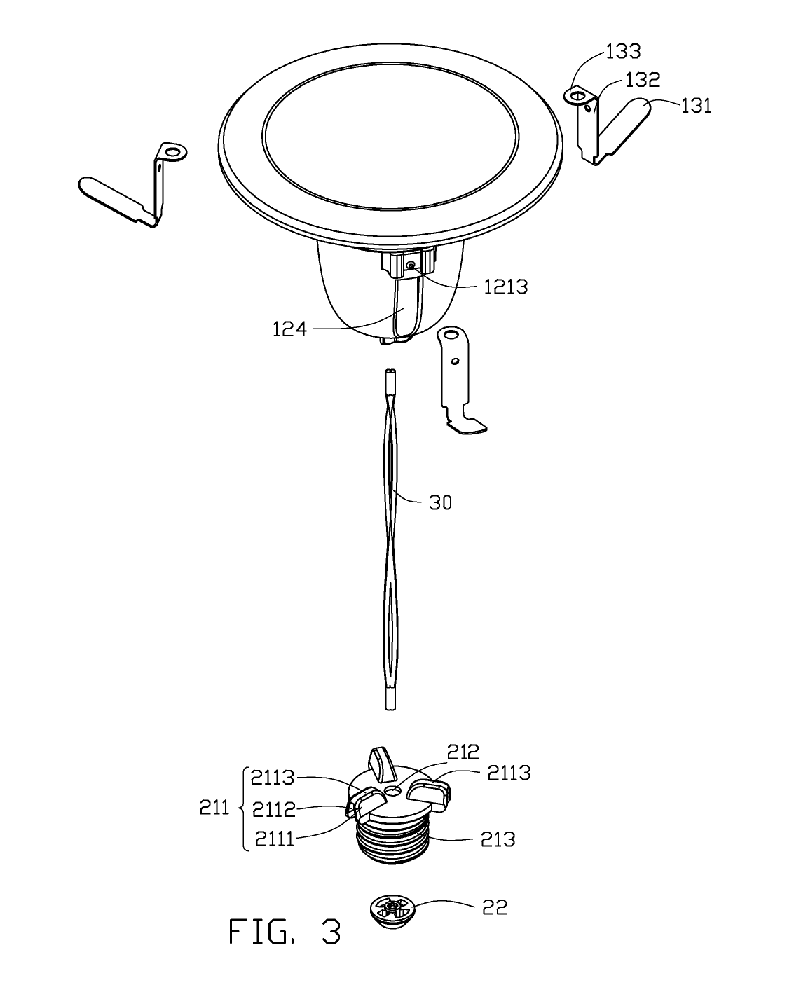

In the illustrated embodiment, the number of the locking pieces 122 is three, and the number of the locking portions 211 is three. The first resisting board 2111, the second resisting board 2112, and the bottom board 2113 can cooperatively form a groove 2114. A width of the groove 2114 can decrease gradually from an end of the groove 2114 away from the main body 21 to another end of the groove 2114. Referring to FIG. 3, a second through hole 212 can be defined in the main body 21 adjacent to the shell 10. A plurality of threads 213 can be formed on an outer wall of the main body 21 for fixedly coupling to an outer structure (not shown). The conductive portion 22 can be fixedly coupled with main body 21 away from the shell 10 and can be used to couple with an outer power source for supplying power.

The electrical cable 30 can be electrically coupled to the conductive portion 22 and a circuit board (not shown) of the shell 10. The electrical cable 30 can be received in the shell 10. The conductive portion 22 can be coupled to the main body 21. Each first fixing portion 132 can be received in the first receiving portion 1211 and fastened with the second housing 12. The electrical cable 30 can be stretched out from the shell 10 for adjusting when the lamp head 20 is spaced from the shell 10 with some distance in use. The electrical cable 30 can be received in the shell 10 when the lamp head 20 and the shell 10 are coupled each other closely.

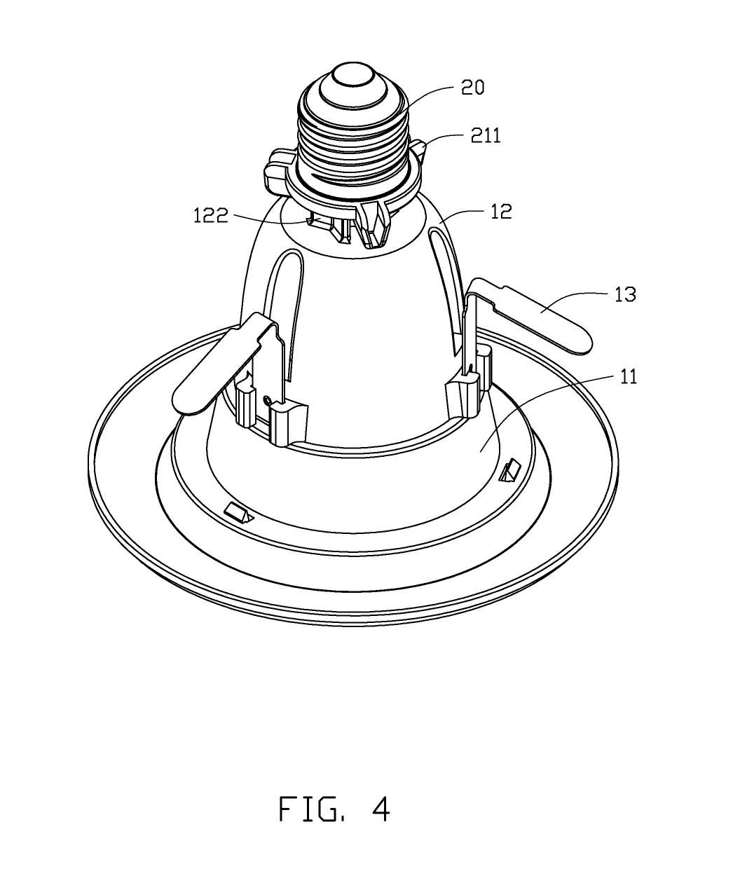

A distance between the lamp head 20 and the shell 10 can be adjusted. Referring to FIG. 4, the electrical cable 30 can be stretched out from the shell 10 via the first through hole 123 when the lamp head 20 needs to be spaced from the shell 10 with some distance. The electrical cable 30 can be received in the shell 10 when each locking portion 211 can be locked in the respective one locking groove 1221 for coupling the lamp head 20 and the shell 10 each other closely.

The embodiments shown and described above are only examples. Many details are often found in the art such as the other features of a lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A lamp comprising:
a shell with an outer surface and an inner surface, the inner shell surface defining a recess and two or more locking pieces extending out from the exterior surface;
a lamp head with an exterior surface and at least one locking portion extending out from the exterior portion; and
an electrical cable having a first end connected to the lamp head and a second end extending into the shell recess;
wherein, the two or more locking pieces are configured to form one or more locking grooves;
wherein, the at least one locking portion is releasably receivable into the one or more locking groove locking the lamp head to the shell; and
wherein, the second end of the electrical cable is connectable to a light positioned in the shell recess with the lamp head, electrical cable and light cooperating to form a circuit loop.

2. The lamp of claim 1, wherein each locking portion comprises a first resisting board, a second resisting board, and a bottom board, the first resisting board and the second resisting board oppositely protrude from a surface of the lamp head adjacent to the shell, the bottom board is coupled between the first resisting board and the second resisting board and positioned adjacent to the shell, the first resisting board and the second resisting board resist against a respective one locking piece when each of the locking portion is received in the respective one locking groove.

3. The lamp of claim 1, wherein the number of the at least two locking pieces is three, and the number of the at least one locking portion is three.

4. The lamp of claim 1, wherein the shell further comprises a first housing and a second housing coupled to the first housing at one end, the at least two locking pieces are positioned on an end of the second housing away from the first housing.

5. The lamp of claim 4, wherein the shell further comprises a clamp piece interconnected with the first housing and the second housing, the clamp piece comprises a main body and a first fixing portion coupled to an end of the main body, a protrusion protrudes from an outer wall of the second housing adjacent to the first housing, a receiving groove is defined in the protrusion, and the first fixing portion is received in the receiving groove.

6. The lamp of claim 5, wherein the clamp piece further comprises a second fixing portion coupled to the first fixing portion away from the main body, the second fixing portion is fixed to an outer surface of the first housing and positioned adjacent to the second housing.

7. The lamp of claim 4, wherein the number of the clamp piece is three, the number of the protrusion is three, and each clamp piece is fixed in a respective one receiving groove.

8. The lamp of claim 4, wherein a first through hole is defined in an end of the second housing adjacent to the first housing, a second through hole is defined in the lamp head adjacent to the shell, the electrical cable passes through the shell and the second through hole.

9. The lamp of claim 1, wherein the lamp head comprises a main body and a conductive portion coupled to an end of the main body away from the shell, the locking portion protrudes from another end of the main body adjacent to the shell, the conductive portion is configured to couple with an outer power source.

10. A lamp comprising:
a shell defining a first through hole;
a lamp head detachably coupled to the shell, the lamp head defining a second through hole;
an electrical cable passing through the first through hole and the second through hole, and the electrical cable electrically coupled to a light in the shell and the lamp head, wherein the electrical cable is stretched out from the shell for adjusting when the lamp head is spaced from the shell with some distance; and
wherein the electrical cable is received in the shell when the lamp head and the shell are coupled each other closely.

11. The lamp of claim 10, wherein the shell has at least two locking pieces, each two adjacent locking pieces of the at least two locking pieces forming a locking groove, the lamp head has at least one locking portion, each locking portion is received and locked in a respective one locking groove when the he lamp head and the shell are coupled each other.

12. The lamp of claim 11, wherein each locking portion comprises a first resisting board, a second resisting board, and a bottom board, the first resisting board and the second resisting board oppositely protrude from a surface of the lamp head adjacent to the shell, the bottom board is coupled between the first resisting board and the second resisting board and positioned adjacent to the shell, the first resisting board and the second resisting board resist against a respective one locking piece when each of the locking portion is received in the respective one locking groove.

13. The lamp of claim 12, wherein a groove is cooperative formed by the first resisting board, the second resisting board, and the bottom board, a width of the groove decreases gradually from an end of the groove away from the surface of the lamp head to another end of the groove.

14. The lamp of claim 11, wherein the shell comprises a first housing and a second housing coupled to the first housing at one end, the at least two locking pieces are positioned on an end of the second housing away from the first housing, the first through hole is defined in an end of the second housing adjacent to the lamp head.

15. The lamp of claim 14, wherein the shell further comprises a clamp piece interconnected with the first housing and the second housing, the clamp piece comprises a main body and a first fixing portion coupled to an end of the main body, a protrusion protrudes from an outer wall of the second housing adjacent to the first housing, a receiving groove is defined in the protrusion, and the first fixing portion is received in the receiving groove.

16. The lamp of claim 15, wherein the clamp piece further comprises a second fixing portion coupled to the first fixing portion away from the main body, the second fixing portion is fixed to an outer surface of the first housing and positioned adjacent to the second housing.

17. The lamp of claim 10, wherein the lamp head comprises a main body and a conductive portion coupled to an end of the main body away from the shell, the locking portion protrudes from another end of the main body adjacent to the shell, the conductive portion is configured to couple with an outer power source, and the second through hole is defined in the main body adjacent to the shell.
